(19) United States
(12) Patent Application Publication
(10) Pub. No.: US 2023/0375466 A1
(43) Pub. Date: Nov. 23, 2023

(54) PESTICIDE DETECTION DEVICE WITH WASHING FUNCTION

(71) Applicant: Taiwan RedEye Biomedical Inc., Hsinchu City (TW)

(72) Inventor: Shuo-Ting YAN, Hsinchu City (TW)

(73) Assignee: Taiwan RedEye Biomedical Inc., Hsinchu City (TW)

(21) Appl. No.: 17/747,100

(22) Filed: May 18, 2022

(51) Int. Cl. G01N 21/31

(52) U.S. Cl. CPC G01N 21/31; G01N 2201/022; B08B 3/12

(57) ABSTRACT

A pesticide detection device with a washing function comprises a detection assembly and a vibration assembly. The detection assembly includes a waterproof casing with an inner space and a detection end, a display disposed on the waterproof casing, a detection channel formed at the detection end of the waterproof casing, a light source module disposed in the inner space of the waterproof casing, a sensor disposed in the inner space of the waterproof casing, and a processor disposed in the inner space and electrically connected to the light source module, the sensor, and the display. The vibration assembly includes a casing having an inner space with a motor, and a vibration element connected to the casing and generating vibration by the motor.

### BACKGROUND OF THE INVENTION

### 1. Field of the Invention

The present invention relates to a pesticide detection device, in particular to a pesticide detection device with a washing function.

### 2. Description of the Prior Arts

Most vegetables and fruits on the market are sprayed with pesticides in order to expel pests. Pesticides can remain on the fruits and vegetables, and most of the pesticides cannot be identified by human's sight and smell. Regardless of the large or small amount of pesticide residues in the human body, it will cause different degrees of physiological damage to the human body. Therefore, washing vegetables and fruits to remove pesticides is very important for human dietary safety.

Most families have the habit of washing vegetables and fruits before cooking. However, when washing vegetables and fruits, most people only rely on experience to determine whether the vegetables and fruits have been washed clean. There is no scientific method for washing vegetables and fruits to ensure that the pesticides of vegetables and fruits are thoroughly washed.

Although there are pesticide detection devices on the market, these pesticide detection devices, such as quick screening reagents or test strips, cannot immediately inform people of the washing status of vegetables and fruits in the most direct and simple way. As a result, people waste more time in washing or are tired of using pesticide detection devices because they are too troublesome. And these inspection methods may also make the vegetables and fruits unsuitable as cooking materials.

On the other hand, it takes a long time to clean the vegetables and fruits by water flushing to remove the pesticides from the vegetables and fruits. People cannot know the pesticide residue status of fruits and vegetables during washing, so it is difficult for them to judge the washing time for fruits and vegetables.

Based on this, the existing pesticide detection device needs to be further improved.

### SUMMARY OF THE INVENTION

In view of the above problems, the present invention provides a pesticide detection device with a washing function, which can instantly detect the pesticide residue in the aqueous solution in the washing container to improve the inspection efficiency, and further enhance the washing effect through vibration.

A pesticide detection device with a washing function comprises:

a detection assembly, including:
a waterproof casing with an inner space and a detection end;
a display disposed on the waterproof casing;
a detection channel formed at the detection end of the waterproof casing;
a light source module disposed in the inner space of the waterproof casing and located at the detection end;
a sensor disposed in the inner space of the waterproof casing and located at the detection end; and
a processor disposed in the inner space and electrically connected to the light source module, the sensor, and the display; and

a vibration assembly, comprising:
a casing having an inner space; wherein the inner space is provided with a motor, and the motor is electrically connected to the processor; and
a vibration element connected to the casing and generating vibration by the motor;

when the processor receives a detection activation signal, the processor activates the motor to generate vibration and activates the light source module to generate a detection light toward the detection channel, and the detection light passes through an aqueous solution in the detection channel;

wherein, when the sensor receives the detection light after passing through the aqueous solution in the detection channel, the sensor generates a spectral information according to the received detection light;

when the processor receives the spectral information, the processor generates a result message according to the spectral information, generates a display information according to the result message, and transmits the display information to the display.

In the pesticide detection device with a washing function of the present invention, the detection assembly is responsible for detecting pesticide, and the vibration assembly is responsible for generating ultrasonic vibration to assist in washing vegetables and fruits. The detection assembly can immediately perform pesticide detection on the aqueous solution when washing vegetables and fruits, and the display information can inform users of the pesticide residue status of washed vegetables and fruits by different lights, such as red, yellow, and green lights, which helps to improve the convenience of pesticide detection. On the other hand, the present invention generates ultrasonic vibration in the aqueous solution by the vibration assembly to assist in washing the pesticide, thereby improving the washing efficiency.

### BRIEF DESCRIPTION OF THE DRAWINGS

FIG. 1 is a perspective view of a pesticide detection device with a washing function of the present invention.

FIG. 2 is a plan view of a first embodiment of the pesticide detection device with a washing function of the present invention.

FIG. 3 is an exploded view of a detection end of the first embodiment of the pesticide detection device with a washing function of the present invention.

FIG. 4 is a cross-sectional view of a detection channel in the first embodiment of the pesticide detection device with a washing function of the present invention.

FIG. 5 is a system block diagram of the pesticide detection device with a washing function of the present invention.

FIG. 6 is a cross-sectional view of a detection channel in a second embodiment of the pesticide detection device with a washing function of the present invention.

FIG. 7 is a plan view of a third embodiment of the pesticide detection device with a washing function of the present invention.

FIG. 8 is a plan view of a fourth embodiment of the pesticide detection device with a washing function of the present invention.

FIG. 9 is a plan view of a fifth embodiment of the pesticide detection device with a washing function of the present invention.

### DETAILED DESCRIPTION OF THE PREFERRED EMBODIMENTS

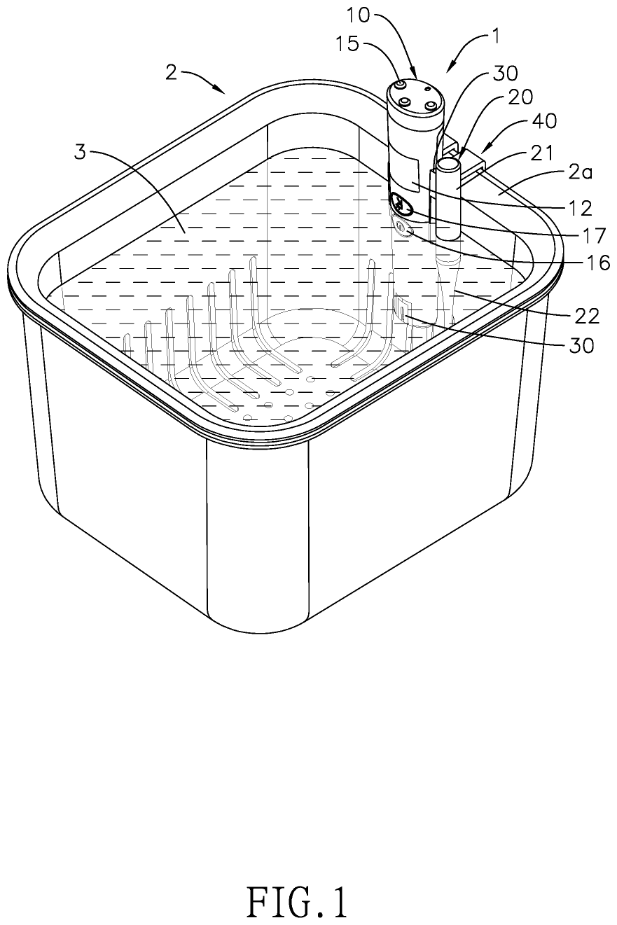

Referring to FIG. 1, the present invention is a pesticide detection device 1 with a washing function. The pesticide detection device 1 with a washing function needs to be installed in a container 2 when in use. The container 2 can be any bucket used for washing vegetables and fruits, and is used to flush the vegetables and fruits in the container 2 with an aqueous solution 3 to dilute the residual pesticides on the vegetables and fruits. This aqueous solution 3 is tap water under normal conditions. The aqueous solution 3 is continuously poured into the container 2 to flush the residual pesticides attached to the surfaces of the fruits and vegetables in the container 2. The aqueous solution 3 fills the container 2 and overflows, so that a pesticide residue concentration of the aqueous solution 3 in the container 2 is continuously diluted. In addition, in the process of diluting the pesticide residues in the surfaces of the vegetables and fruits, the pesticide detection device 1 with a washing function of the present invention further improves the washing effect through vibration, and continuously detects the pesticide residue concentration in the aqueous solution, so as to inform a user of the pesticide residue status of the vegetables and fruits in the most immediate and direct way.

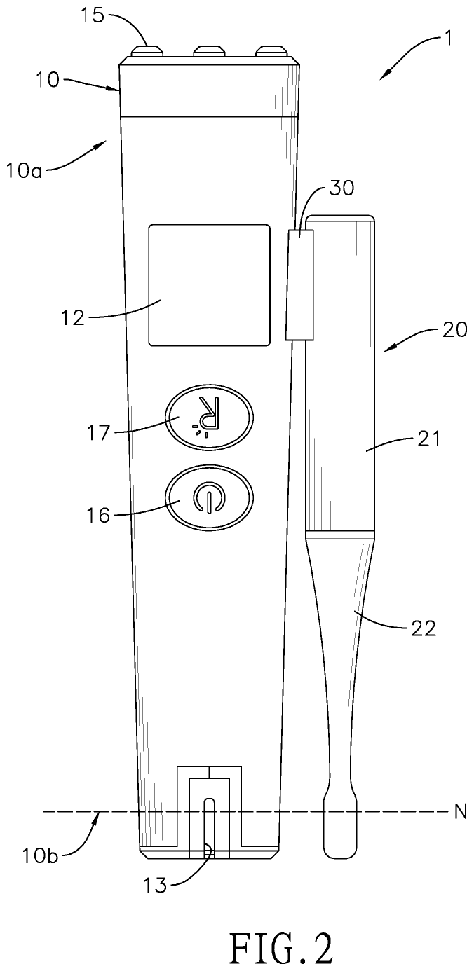

Further referring to FIG. 2, the pesticide detection device 1 with a washing function of the present invention includes a detection assembly 10 and a vibration assembly 20. The vibration assembly 20 is disposed outside the detection assembly 10 and is connected to the detection assembly 10 through a buffer 30. The pesticide detection device 1 with a washing function further includes a hanger 40. Wherein the buffer 30 can be made of elastic materials, such as rubber, to reduce the vibration on the detection assembly 10 when the vibration assembly 20 operates. The hanger 40 is used for engaging the detection assembly 10 and can be hung on an edge 2a of the container 2. Then the pesticide detection device 1 with a washing function can be fixed on the edge 2a regardless of the size of the container 2a, which is convenient for the user to take.

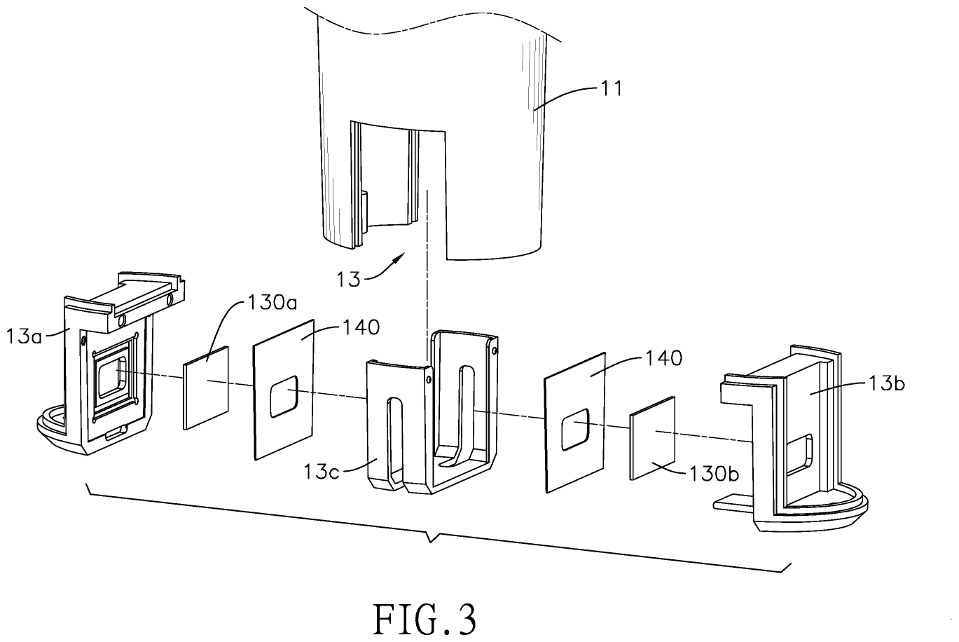

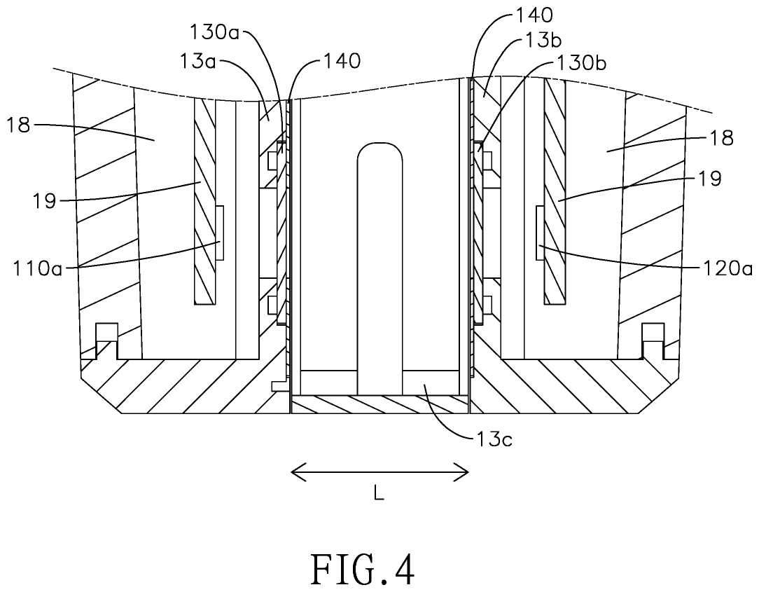

Further referring to FIGS. 3 and 4, the detection assembly 10 includes a waterproof casing 11, a display 12 and a detection channel 13. The waterproof casing 11 has an inner space 18 and a detection end 10b. The detection end 10b can be immersed in the aqueous solution 3. The waterproof casing 11 protects the inner space 18 from the aqueous solution 3. The display 30 is disposed on the waterproof casing 11, and the detection channel 13 is formed on the detection end 10b of the waterproof casing 11.

In a first embodiment, the pesticide detection device 1 of the present invention further comprises a light source module 110a and a sensor 120a. The light source module 110 a and the sensor 120 are respectively disposed on opposite sides of the detection channel 13 and disposed on at least one circuit board 19 in the inner space 18. The detection channel 13 is formed in the detection end 10b of the waterproof casing 11 in the shape of a gate. A first light-transmitting lens 130a and a second light-transmitting lens 130b are respectively disposed on opposite sides of the detection channel 13. A waterproof cover 140 is disposed between the aqueous solution 3 and the first light-transmitting lens 130a. The waterproof cover 140 is also provided between the aqueous solution 3 and the second light-transmitting lens 130b to prevent the aqueous solution 3 from flowing into the inner space 18. In addition, the light source module 110a and the sensor 120a are respectively disposed beside the first light-transmitting lens 130a and the second light-transmitting lens 130b.

The vibration assembly 20 includes a casing 21 and a vibration element 22. The vibration element 22 is connected to the casing 21 and is to be immersed in the aqueous solution 3. The casing 21 has an inner space that communicates with the inner space 18 of the waterproof casing 11 of the detection assembly 10 through the buffer 30.

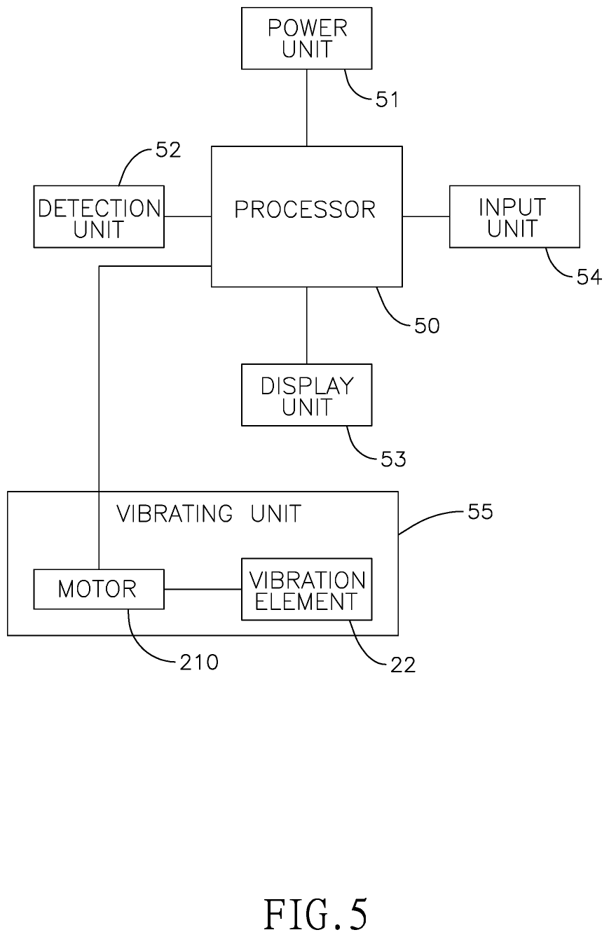

Referring to FIG. 5, the detection assembly 10 further includes a processor 50. The processor 50 is disposed on the at least one circuit board 19 in the inner space 18. The processor 50 is electrically connected to the light source module 110a, the sensor 120a, and the display 12. A motor 210 is provided in the inner space of the casing 21 of the vibration assembly 20, and the motor 210 is electrically connected to the processor 50 in the inner space 18 of the waterproof casing 11 of the detection assembly 10 through the buffer 30. The motor 210 causes the vibration element 22 to generate ultrasonic vibration, and the ultrasonic vibration can remove the pesticide residues from vegetables and fruits, which can enhance the washing effect.

Further, the processor 50 is an arithmetic control unit. For example, the arithmetic control unit can be a central processing unit (CPU) or a microcontroller unit (MCU), and is disposed on the at least one circuit board 19. The processor 50 is connected to a power unit 51 that supplies power, a detection unit 52 that detects the aqueous solution 3, a display unit 53 that displays the state of the pesticide detection device 1, an input unit 54 that receives an input, and a vibrating unit 55 that generates ultrasonic vibration. The processor 50 controls the operation of the pesticide detection device 1, and the power unit 51 is used for outputting electric power to the pesticide detection device 1. The detection unit 52 includes the light source module 110a and the sensor 120a. The detection unit 52 measures the aqueous solution 3 and then returns a spectral information to the processor 50 for processing. The input unit 54 includes a power switch 16 and a measuring switch 17. The vibration unit 55 includes the motor 210 and the vibration element 22. When the power switch 16 generates a power-on signal, the power unit 51 outputs power to the processor 50 to start the processor 50. The display unit 53 includes the display 12, and the vibration unit 55 is connected to the motor 210. When the processor 50 detects a detection activation signal generated by the measuring switch 17, the processor 50 controls the detection unit 52 and the display unit 53 to work, or activates the vibration unit 55 and controls the motor 210 of the vibration unit 55 to make the vibration element 22 generate ultrasonic vibration. The motor 210 is powered by the power unit 51.

When the processor 50 receives the detection activation signal, the processor 50 first activates the light source module 110 to emit a detection light to the detection channel 13. After the detection light is emitted from the light source module 110a, it passes through the first light-transmitting lens 130a, the aqueous solution 3 in the detection channel 13 and the second light-transmitting lens 130b, and then is emitted into the sensor 120a. The sensor 120a generates the spectral information according to the received detection light. The processor 50 receives the spectral information, generates a result message according to the spectral information, generates a display information according to the result message, and transmits the display information to the display 12. Then the display 12 displays the display information.

Referring to FIG. 3 and FIG. 4, the detection channel 13 is composed of a first holder 13a, a second holder 13a and a grid 13c. The first holder 13a and the second holder 13a are combined with each other to form the detection channel 13. The grid 13c is detachably disposed in the detection channel 13 having a detection channel distance L to filter the aqueous solution 3, so that the branches and leaves of vegetables will not block or scratch the first light-transmitting lens 130a or the second light-transmitting lens 130b.

In the first embodiment, the first holder 13a is used to fix the light source module 110a and the first light-transmitting lens 130a, so that the light source module 110a and the first light-transmitting lens 130a are tightly coupled. The second holder 13a is used for fixing the sensor 120a and the second light-transmitting lens 130b, so that the sensor 120a and the second light-transmitting lens 130b are tightly coupled. The advantage of tightly coupling these components is that the less medium the light travels through, the simpler the light path is. That is to say, the light path of the detection light only includes the mediums of the first light-transmitting lens 130a, the aqueous solution 3 and the second light-transmitting lens 130b as far as possible. The detection light travels through air hardly. Furthermore, the advantage of tightly coupled components is that the detection light can be perpendicularly incident on the first light-transmitting lens 130a and the second light-transmitting lens 130b, so that the detection light will not be refracted and lose intensity due to non-normal incidence.

In the first embodiment, the pesticide detection device 1 further includes a plurality of charging ports 15 disposed on a charging end 10a of the waterproof casing. The detection end 10b and the charging end 10a of the waterproof casing 11 are disposed opposite to each other, that is, the detection end 10b and the charging end 10a are opposite ends of the waterproof casing 11. The pesticide detection device 1 in the first embodiment can be charged while it is also detecting the aqueous solution 3. As the detection end 10b needs to be submerged in the aqueous solution 3 during detection, due to the charging end 10a is opposite to the detection end 10b, the charging end 10b will not be submerged in the aqueous solution 3 and in a position higher than the level of the aqueous solution 3. Specifically, the position where the hanger 40 engages with the waterproof casing 11 is lower than the position of the charging end 10a and higher than the position of the detection end 10b, and the hanger 40 is hung on the edge of the container 2. When the aqueous solution 3 fills the container 2, the level of the aqueous solution 3 is close to the periphery of the container 2. Therefore, the position of the charging end 10a is higher than the level of the aqueous solution 3 in the container 2. That is, even though the container 2 is filled with the aqueous solution 3, the charging end 10a will not be submerged in the aqueous solution 3, but can be charged while detecting.

In the first embodiment, the power switch 16 and the measuring switch 17 are disposed on the waterproof casing 11. The power switch 16 and the measuring switch 17 are waterproof switches. So they can be combined with the waterproof casing 11 to prevent the aqueous solution 3 from flowing into the inner space 18. By controlling the power switch 16 and the measuring switch 17, the user can turn on the pesticide detection device 1 through the power switch 16, and can activate the pesticide detection device 1 to operate through the measuring switch 17. For example, when the power switch 16 is pressed by the washer, the power switch 16 generates the power-on signal to turn on the processor 50. And when the measuring switch 17 is pressed by the user, the measuring switch 17 generates the detection activation signal. When the processor 50 detects the detection activation signal, the light source module 110a and the sensor 120a start to continuously detect the aqueous solution 3, and continuously detect the pesticide residue concentration of the aqueous solution 3 until the power switch 16 or the measuring switch 17 is turned off, or continuously detect the pesticide residue concentration of the aqueous solution 3 until the pesticide residue concentration is lower than a safe threshold. The present invention starts to continuously detect the aqueous solution 3 after the user presses the measuring switch 17, which can save power, reduce the use time of the light source module 110a and the sensor 120a, and prolong the service life of the light source module 110a and the sensor 120a.

In the first embodiment, the detection unit 52 and the vibration unit 55 operate synchronously, that is, when the processor 50 receives the detection activation signal, the processor 50 simultaneously activates the detection unit 52 to inspect pesticides in the aqueous solution 3 and starts the vibration unit 55 to generate vibration to assist cleaning vegetables and fruits. In addition, in the second embodiment, the detection unit 52 and the vibration unit 55 operate asynchronously. That is, when the processor 50 receives the detection activation signal, the processor 50 first activates the vibration unit 55 to generate vibration to enhance the washing effect, after a washing time, turns off the vibration unit 55 to stop vibrating, and then activates the detection unit 52 to detect pesticide. By working at different times, the detection result is prevented from be interfering by the vibration generated by the vibration unit 55. In this way, the user can detect the current pesticide residue status while washing, so as to improve the washing efficiency.

In the first embodiment, the light source module 110a and the sensor 120a are disposed on an optical axis N shown in FIG. 2, and the detection assembly 10 and the vibration assembly 20 are disposed along the optical axis N, which means that the vibration assembly 20 is disposed on the side of the detection assembly 10. The optical axis N is formed by extending the connection line between the light source 110a module and the sensor 120a.

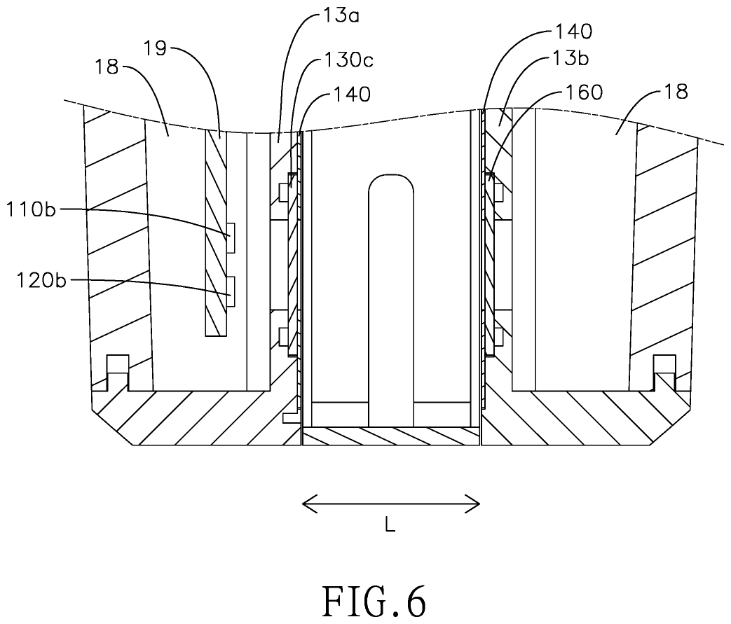

Referring to FIG. 6, the difference between the second embodiment and the first embodiment is that a light-transmitting lens 130c and a reflecting lens 160 are respectively disposed on opposite sides of the detection channel 13. The light source module 110b and the sensor 120b are both disposed on the at least one circuit board 19 on the side of the detection channel 13 where the light-transmitting lens 130c is provided. After the detection light is emitted from the light source module 110b, the detection light passes through the light-transmitting lens 130c and the aqueous solution 3 in the detection channel 13, is reflected by the reflection lens 160, passes through the aqueous solution 3 in the detection channel 13 and the aqueous solution 3 in the detection channel 13, and then is emitted into the sensor 120b. In this way, the path of the detection light in the aqueous solution 3 can be increased, thereby further improving the detection accuracy.

When the processor 50 receives the spectral information, the processor 50 generates a light absorptivity according to the spectral information. The processor 50 has a first threshold and a second threshold, and the second threshold is greater than the first threshold. The first threshold and the second threshold may be used as the criteria for determining the pesticide concentration in the aqueous solution. The determining processes are as follows:

when the processor 50 determines that the light absorptivity is higher than the second threshold, it means that the pesticide concentration exceeds the standard, and the display information generated by the processor 50 is a red light;

when the processor 50 determines that the light absorptivity is between the first threshold and the second threshold, it means that the pesticide concentration has been reduced but still exceeds the standard, and the display information generated by the processor 50 is a yellow light;

when the processor 50 determines that the light absorptivity is lower than the first threshold, it means that the pesticide concentration is within the acceptable range, and the display information generated by the processor 50 is a green light.

In the first embodiment and the second embodiment, each of the light source modules 110a, 110b includes a first light source and a second light source. The first light source generates and emits a first wavelength light, and the wavelength of the first wavelength light is 260 nm. The second light source generates and emits a second wavelength light, and the wavelength of the second wavelength light is 365 nm. Specifically, the detection light includes the first wavelength light and the second wavelength light. The spectrum information includes a first spectrum information and a second spectrum information. When the sensors 120a, 120b receive the detection light passing through the aqueous solution 3 in the detection channel 13, the sensors 120a, 120b generate the first spectral information according to the received first wavelength light, and the sensors 120 generate the second spectral information according to the received second wavelength light. Then, when the processor 50 receives the first spectral information and the second spectral information, the processor 50 further generates a first wavelength light absorptivity according to the first spectral information and a second wavelength light absorptivity according to the second spectral information.

At this time, the processor 50 sets the first threshold as the basis for determining the first wavelength light absorptivity, which is as follows:

when the processor 50 determines that the first wavelength light absorptivity is higher than the first threshold and the second wavelength light absorptivity is lower than the first wavelength light absorptivity, the result message generated by the processor 50 is that the aqueous solution 3 contains pesticide residues;

when the processor 50 determines that the first wavelength light absorptivity is higher than the first threshold, and the second wavelength light absorptivity is higher than the first wavelength light absorptivity, the result message generated by the processor 50 is a message that the aqueous solution 3 contains pesticide residues and impurities; and

when the processor 50 determines that the first wavelength light absorptivity is lower than the first threshold, and the second wavelength light absorptivity is higher than the first wavelength light absorptivity, the result message generated by the processor 50 is a message that the aqueous solution 3 contains impurities but no pesticide residues.

In other words, the first wavelength light is for detecting the concentration of pesticides, and the second wavelength light is for detecting the concentration of impurities. When the first wavelength light absorptivity is higher than the first threshold, it means that the concentration of pesticide residues in the aqueous solution 3 exceeds the standard concentration. When the first wavelength light absorptivity is lower than the first threshold, it means that the pesticide residue concentration in the aqueous solution 3 does not exceed the standard concentration.

In addition, when the second wavelength light absorptivity is higher than the first wavelength light absorptivity, it means that there are impurities exceeding the standard concentration in the aqueous solution 3. Because impurities block the second wavelength light, the sensor 120a receives less of the second wavelength light, which causes the second wavelength light absorptivity to be higher than the first wavelength light absorptivity. When the second wavelength light absorptivity is lower than the first wavelength light absorptivity, it means that there is no impurity exceeding the standard concentration in the aqueous solution 3. The criteria for determining the concentrations of pesticides and impurities can be adjusted in the first embodiment and the second embodiment.

In addition, when the result message generated by the processor 50 is the message that the aqueous solution 3 contains pesticide residues and impurities or contains impurities but no pesticide residues, the display information generated by the processor 50 is an abnormal result, which means the aqueous solution 3 is too turbid to detect.

Further, when the second wavelength light absorptivity is lower than the first wavelength light absorptivity, it means that there are less impurities in the aqueous solution 3. Therefore, the processor 50 further determines whether the first wavelength light absorptivity is lower than the first threshold, or determines whether the first wavelength light absorptivity is between the first threshold and the second threshold, or determines whether the first wavelength light absorptivity is higher than the second threshold, which is as follows:

when the processor 50 determines that the first wavelength light absorptivity is higher than the second threshold, it means that the pesticide concentration exceeds the standard, and the display information generated by the processor 50 is a red light;

when the processor 50 determines that the first wavelength light absorptivity is between the first threshold and the second threshold, it means that the pesticide concentration is reduced but still exceeds the standard, and the display information generated by the processor 50 is a yellow light;

when the processor 50 determines that the first wavelength light absorptivity is lower than the first threshold, it means that the pesticide concentration is within the acceptable range, and the display information generated by the processor 50 is a green light.

For example, when the measuring switch 17 is pressed by a user, the measuring switch 17 generates the detection activation signal and the processor 50 controls the light source module 110a and the sensor 120a to continuously detect the aqueous solution 3. When the user starts to clean the vegetables and fruits, the pesticide residue concentration in the aqueous solution 3 is the highest, which makes the first wavelength light absorptivity higher than the second threshold value. Then the display information shows a red light. When the user sees the red light on the display, it means that the vegetables and fruits continue to be washed. And as the user continues to clean the fruits and vegetables, the concentration of pesticide residues in the aqueous solution 3 continues to decrease. When the concentration of pesticide residues in the aqueous solution 3 continues to decrease and causes the first wavelength light absorptivity to be between the second threshold and the first threshold, the display information shows a yellow light. It means that the pesticide concentration in the aqueous solution 3 has decreased but still exceeds the standard, and the user still needs to continue cleaning the vegetables and fruits. When the concentration of pesticide residues in the aqueous solution 3 continues to decrease and causes the first wavelength light absorptivity to be lower than the first threshold, the display information shows a green light. It means the concentration of pesticides in the aqueous solution 3 is within a safe range, and the user can stop washing the fruits and vegetables.

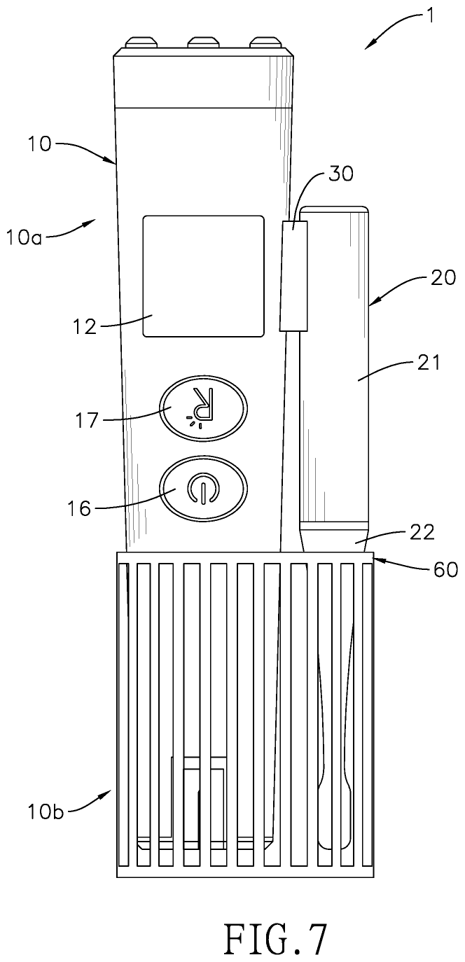

Referring to FIG. 7, in the third embodiment, the pesticide detection device 1 with a washing function further includes a fixed grid 60. The fixed grid 60 is fixed on the waterproof casing 11 of the detection assembly 10 and surrounds the detection end 10b of the detection assembly 10 and the vibration element 22 of the vibration assembly 20. In this way, the fixed grid 60 can prevent the detection assembly 10 and the vibration assembly 20 from colliding with the vegetables and fruits, thereby prolonging the service life of the pesticide detection device 1 with a washing function.

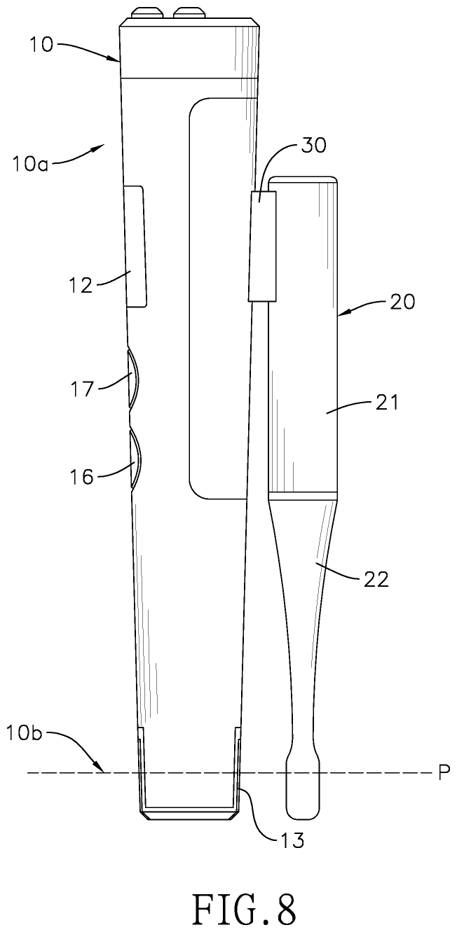

Referring to FIG. 8, the difference between the fourth embodiment and the first embodiment is that a channel path P is defined in the direction of the detection channel 13, and the detection assembly 10 and the vibration assembly are disposed along the channel path P. That is to say, the vibration assembly can be disposed on the back of the detection assembly 10.

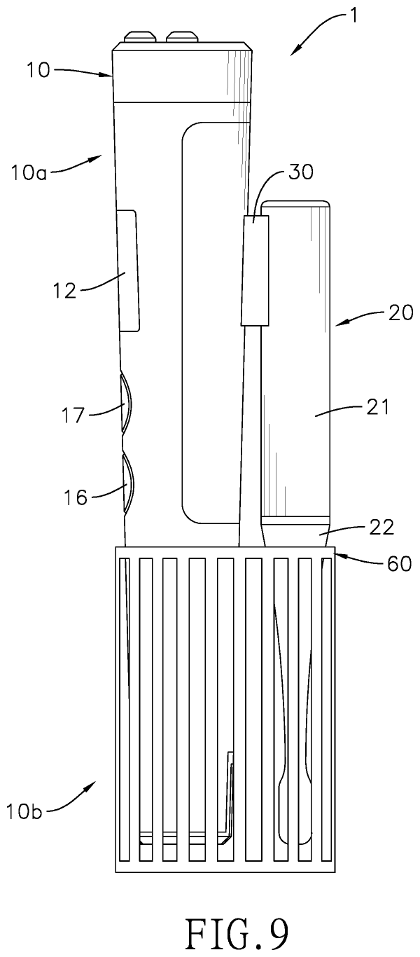

Referring to FIG. 9, the difference between the fifth embodiment and the fourth embodiment is that the pesticide detection device 1 with a washing function further includes a fixed grid 60. The fixed grid 60 is fixed on the waterproof casing 11 of the detection assembly 10 and surrounds the detection end 10b of the detection assembly 10 and the vibration element 22 of the vibration assembly 20. In this way, the fixed grid 60 can prevent the detection assembly 10 and the vibration assembly 20 from colliding with the vegetables and fruits, thereby prolonging the service life of the pesticide detection device 1 with a washing function.

In summary, the detection assembly 10 of the pesticide detection device 1 with a washing function of the present invention can immediately detect pesticides in the aqueous solution when washing vegetables and fruits, and inform the user of the pesticide residue status of vegetables and fruits through the display information with red light, yellow light, and green light, thereby improving the convenience of pesticide detection. On the other hand, the present invention can generate ultrasonic vibration in the aqueous solution 3 through the vibration assembly 20 to wash away pesticides, thereby further improving the washing efficiency.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A pesticide detection device with a washing function, comprising:
a detection assembly comprising:
a waterproof casing having an inner space and a detection end;
a display disposed on the waterproof casing;
a detection channel formed at the detection end of the waterproof casing;
a light source module disposed in the inner space of the waterproof casing and located at the detection end;
a sensor disposed in the inner space of the waterproof casing and located at the detection end; and
a processor disposed in the inner space and electrically connected to the light source module, the sensor and the display; and
a vibration assembly comprising:
a casing having an inner space; wherein a motor is provided in the inner space and electrically connected to the processor; and
a vibration element connected to the casing and generating vibration by the motor;
when the processor receives a detection activation signal, the processor activates the motor to generate vibration and activates the light source module to generate a detection light toward the detection channel, and the detection light passes through an aqueous solution in the detection channel;
wherein, when the sensor receives the detection light after passing through the aqueous solution in the detection channel, the sensor generates a spectral information according to the received detection light;
when the processor receives the spectral information, the processor generates a result message according to the spectral information, generates a display information according to the result message, and transmits the display information to the display; the display shows the display information.

2. The pesticide detection device with a washing function as claimed in claim 1, wherein the light source module and the sensor are disposed on an optical axis, and the detection assembly and the vibration assembly are disposed along the optical axis;
the optical axis of the detection assembly is defined along a virtual connection line between the light source module and the sensor.

3. The pesticide detection device with a washing function as claimed in claim 1, wherein the detection channel has a channel path in the channel direction, and the detection assembly and the vibration assembly are disposed along the channel path.

4. The pesticide detection device with a washing function as claimed in claim 1, further comprising:
a buffer, wherein the vibration assembly is connected to the detection assembly through the buffer and is disposed outside the detection assembly.

5. The pesticide detection device with a washing function as claimed in claim 1, further comprising:
a fixed grid fixed on the waterproof casing of the detection assembly and surrounding the detection end of the detection assembly and the vibration element of the vibration assembly.

6. The pesticide detection device with a washing function as claimed in claim 1, wherein when the processor receives the detection activation signal, the processor simultaneously activates the motor to generate vibration and activates the light source module to generate the detection light toward the detection channel.

7. The pesticide detection device with a washing function as claimed in claim 1, wherein when the processor receives the detection activation signal, the processor first activates the motor to generate vibration, after a washing time, turns off the vibration assembly, and then activates the light source module to generate the detection light toward the detection channel.

8. The pesticide detection device with a washing function as claimed in claim 1, wherein a first light-transmitting lens and a second light-transmitting lens are respectively disposed on opposite sides of the detection channel;
wherein the light source module and the sensor are respectively disposed on the opposite sides of the detection channel;
wherein, after the light source module emits the detection light, the detection light is emitted to the sensor through the first light-transmitting lens, the aqueous solution in the detection channel and the second light-transmitting lens.

9. The pesticide detection device with a washing function as claimed in claim 1, wherein a light-transmitting lens and a reflecting lens are disposed on opposite sides of the detection channel;
wherein the light source module and the sensor are both disposed on the same side of the detection channel where the light-transmitting lens is disposed;
wherein, after the light source module emits the detection light, the detection light passes through the light-transmitting lens and the aqueous solution in the detection channel, is reflected by the reflecting lens to pass through the aqueous solution in the detection channel and the light-transmitting lens, and then is emitted into the sensor.

10. The pesticide detection device with a washing function as claimed in claim 1, where the light source module includes:
a first light source generating and emitting a first wavelength light; and
a second light source generating and emitting a second wavelength light; and
wherein the detection light includes the first wavelength light and the second wavelength light;
wherein the spectral information includes a first spectral information and a second spectral information;
wherein, when the sensor receives the detection light after passing through the aqueous solution in the detection channel, the sensor generates the first spectral information according to the first wavelength light and generates the second spectral information according to the second wavelength light;
when the processor receives the first spectral information and the second spectral information, the processor generates a first wavelength light absorptivity according to the first spectral information, and generates a second wavelength light absorptivity according to the second spectral information;
when the processor determines that the first wavelength light absorptivity is higher than a first threshold and the second wavelength light absorptivity is lower than the first wavelength light absorptivity, the result message generated by the processor is a message that the aqueous solution contains pesticide residues;
when the processor determines that the first wavelength light absorptivity is higher than the first threshold, and the second wavelength light absorptivity is higher than the first wavelength light absorptivity, the result message generated by the processor is a message that the aqueous solution contains pesticide residues and impurities;
when the processor determines that the first wavelength light absorptivity is lower than the first threshold and the second wavelength light absorptivity is higher than the first wavelength light absorptivity, the result message generated by the processor is a message that the aqueous solution contains impurities but no pesticide residues.
